(19) United States
(12) Patent Application Publication
(10) Pub. No.: US 2024/0127217 A1
(43) Pub. Date: Apr. 18, 2024

(54) Prepaid currency platform

(71) Applicant: Shawn Snow, Hollywood, FL (US)

(72) Inventor: Shawn Snow, Hollywood, FL (US)

(21) Appl. No.: 17/803,674

(22) Filed: Oct. 7, 2022

(51) Int. Cl. G06Q 20/28; G06Q 20/32

(52) U.S. Cl. CPC G06Q 20/28; G06Q 20/322

(57) ABSTRACT

A platform that provides individuals and businesses with the ability to lock in a particular price of services and products by pre-paying for them and allows them use anytime in the future with no expiration dates, even years later. To lock in current prices, so that money is being saved and hedge against future inflation. The platform comprises of different modules which can be used alone or in combination. The present invention platform allows individuals and businesses to securely and easily setup and track prepaid transactions, transfer of funds for the prepaid services and products, and other related functions with others in one convenient platform. From account signup through to funds settlement, users (individuals and businesses) can access the platform from a cell phone, tablet, laptop computer, desktop computer or other internet enabled devices.

### FIELD OF INVENTION

The present invention relates to a pre-paid currency platform system for purchasing products or services. The platform comprises different modules which can be used alone or in combination. The platform allows individuals and businesses with the ability to securely and easily to lock in prices of services and products by pre-paying for them using any electronic Internet enabled device such as a cell phone, tablet, laptop, computer, desktop computer or other related internet browser.

### BACKGROUND OF INVENTION

A medium of exchange is any item that is widely acceptable in exchange for goods and services. In modern economies, the most commonly used medium of exchange is currency.

The origin of “mediums of exchange” in human societies is assumed to have arisen in antiquity as awareness grew of the limitations of barter. The form of the “medium of exchange” follows that of a token, which has been further refined as money. Currencies is a standardization of money in any form, in use or circulation as a medium of exchange, for example banknotes and coins. A more general definition is that a currency is a system of money in common use within a specific environment over time, especially for people in a nation state. Under this definition, U.S. dollars (US$), Indian rupee ( [symbol] ), euros (€), Japanese yen (¥), and pounds sterling (£) are examples of (government-issued) fiat currencies. In finance, an exchange rate or a foreign exchange rate or a forex rate or an FX rate (i.e., e t ($/€)) between two currencies is the rate at which one currency will be exchanged for another. Exchange rate is the price (value) of one country's currency in terms of another country's currency. Many items have been used as commodity money, such as animals, barley, wine, oil, cowrie shells, beads, and naturally occurring rare precious metals and stones, as well as many other things that be considered as valuable to the average person. Most ancient moneys started to become tokens a long time ago. In many financial transactions, it is customary to quote prices in other ways. “Price” sometimes refers to the quantity of payment requested by a seller of goods or services. This requested amount is often called the asking price or selling price. Price is the quantity of payment offered by a buyer of goods or services. Economic price theory asserts that in a free-market economy the market price reflects interaction between supply and demand. In the modern economy, individuals and businesses pay and receive services and products at the same time. Payment methods can include paper money of that particular government (example, US Dollar), debit card, credit cards, check, or bank wire for larger purchases where the money is changed in real time from buyer to seller. Services and products are mostly consumed instantly or purchased and made use of at a later date. For example, getting a haircut (the service) and paying for it immediately after that service is provide or purchasing a coupon and making use of it at a later date.

Prepaid refers to services paid for in advance generally. Examples include postage stamps, tolls, public transit cards, pay as you go cell phones, and stored-value cards such as gift cards and preloaded credit cards. Prepaid options can have substantial cost reductions over postpaid counterparts because they allow customers to monitor and budget usage in advance. The terms Prepaid has been majorly attributed to Phone Plans or Prepaid Debit/Credit Cards which is money that you load on a particular card and then use it when needed.

### SUMMARY OF THE INVENTION

People have been using the Prepaid concept for a long time. While this concept is not new, the invention (Prepaid Currency Platform) (also referred to as Prepaid Notes) has a created a platform that with many unique features and benefits. Prepaid Notes™ is a trademark that is being claimed and used in commerce by the applicant and should be noted. Throughout patent publication invention is referred to Prepaid Currency Platform and in a few instances by the trademark name (Prepaid Notes).

The following summary is provided to facilitate an understanding of some of the innovative features unique to the present invention. This is not intended to be a full description. A full description of the various aspects of the invention can be gained by taking the entire specification, claims, and abstract as a whole.

The present invention relates to a platform that provides individuals and businesses with the ability to lock in a particular price of services and products by pre-paying for them and allows them use anytime in the future with no expiration dates, even years later. To lock in current prices, so that money is being saved and hedge against future inflation. The platform comprises of different modules which can be used alone or in combination. The present invention platform allows individuals and businesses to securely and easily setup and track prepaid transactions, transfer of funds for the prepaid services and products, and other related functions with others in one convenient platform. From account signup through to funds settlement, users (individuals and businesses) can access the platform from a cell phone, tablet, laptop computer, desktop computer or other internet enabled devices.

An example of a Prepaid Currency Platform transaction is as follows, a buyer purchased $50 in services from a hair salon (haircut current price $18) and then 2 years later decided to use some of their Prepaid Notes (haircut current price changed to $23, an increase in almost 30%). Both user accounts have a copy of the service/product list of that timeframe to verify the haircut price, and that original price is the one that gets deducted from the Prepaid Currency Platform as used and updated in both user accounts.

The Prepaid Currency Platform offers many benefits to its buyers such as a free service to buyers. Helps to save money and hedge against inflation. Lock in today's price and also on sales and promotions when available. It can be used anytime in the future even years after with no expiration date or restrictions. The platform also serves as a means to buy as an investment. The Cost of living goes up all the time and as a result products and services go up. The present invention allows a user to buy and hold, use, transfer or sell, etc. As you would any other investment. The invention offers a charge free transaction for transfer to others. It also makes a great gift with no service fees added to purchase.

The Prepaid Currency Platform offers many benefits to its sellers such as building customer loyalty. Edge over competition. Give users an option to save money both now and in the future. Let buyers invest in company; as with stocks, a user can buy and hold for years and when prices are much higher, Prepaid Notes can be used or sold for profit. Increase cash flow, revenue and profits. Increase company's ability to expand internally rather than just from loans. Use funds to pay down outstanding loans, saving the company interest and other charges.

### BRIEF DESCRIPTION OF DRAWINGS

FIG. 1 illustrates a user view of the platform of the current invention that may be used to search for one or more aspects of the present invention;

FIG. 2 illustrates a user option of the current invention platform that may be used to purchase an aspect of the present invention as depicted in FIG. 1;

FIG. 3 illustrates a process of providing a payment requested order in a series of option to a recipient.

FIG. 4 illustrates a user option of the current invention platform that may be used as depicted in FIG. 3;

FIG. 5 illustrates a process that includes steps to address two methods of requesting a transfer or gift of funds to a friend or recipient;

FIG. 6 illustrates a business user view of the platform of the current invention that may be used to search for one or more aspects of the present invention;

FIG. 7 illustrates a business user payment option of the platform for current invention as depicted in FIG. 6;

FIG. 8 illustrates a business user payment option of the platform of the current invention.

### DETAILED DESCRIPTION OF THE DRAWINGS

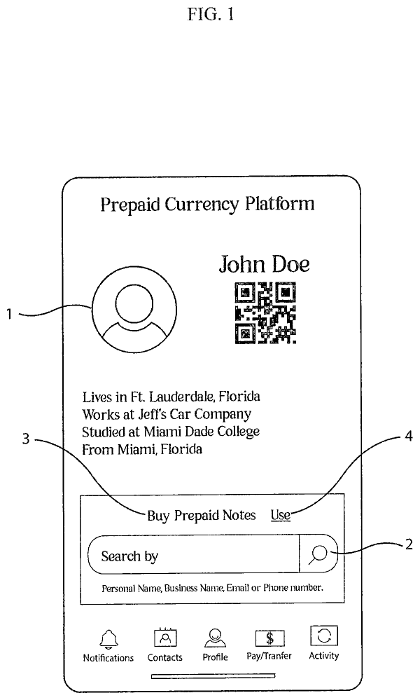

FIG. 1, discloses a user sign up page and screen which further displays user personal information such as name, address, and contacts (1), other options such as notifications, activity, and scannable bar code are also displayed. User would search for the business that they want to buy Prepaid Offer from in search bar (2), or scan a QR Code by that business to get to their page. Buy prepaid notes (3) or use prepaid notes (4). They can also use shopping cart to make purchases.

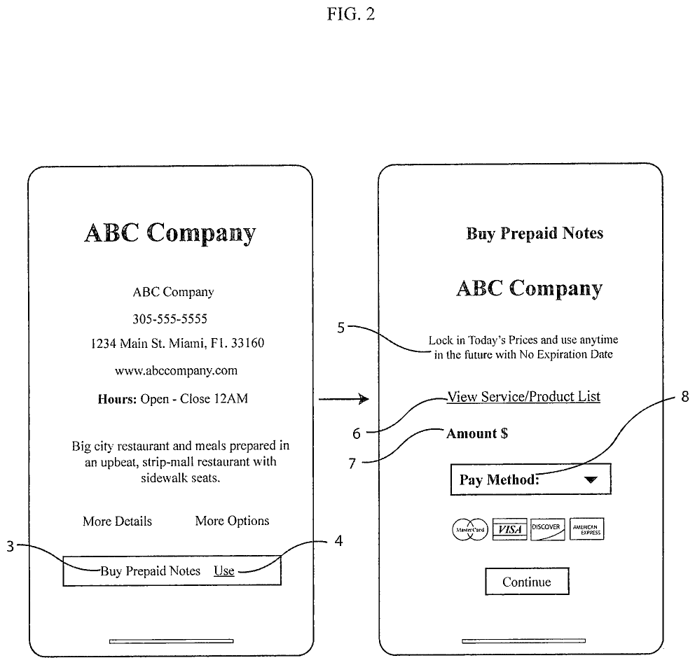

FIG. 2, discloses a user view of the present invention as discussed above, wherein a user searches for a business and view services/product list as provided (6). The user can further buy prepaid notes (3), and lock in today prices of goods and or services of business selected or searched (5). The user can further view service product list (6), select desired amount to be paid (7) and the payment option (8).

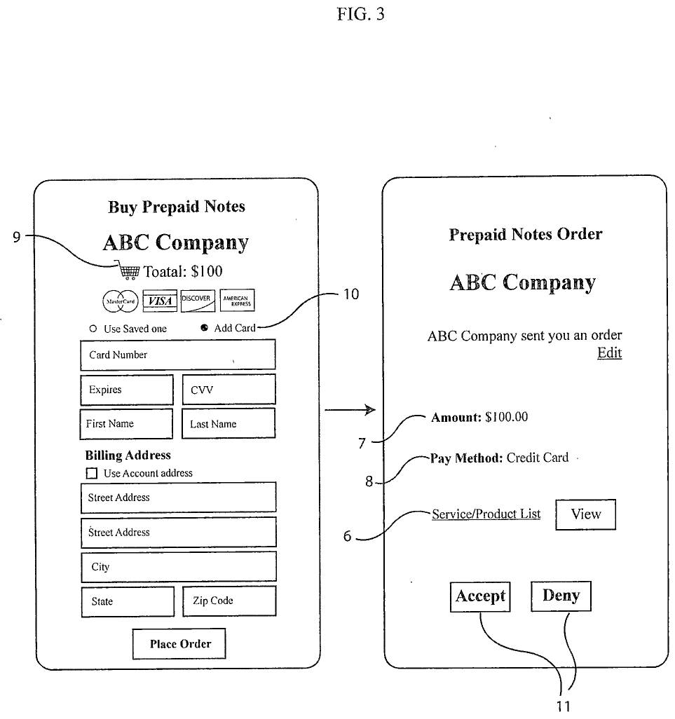

FIG. 3, discloses the user platform order page of the present invention. This further reveals the company name and information, service product list (6), amount (7), payment method (8), total amount in cart (9), add card option (10), and billing information. The page further allows for an option to accept or decline transaction or order (11).

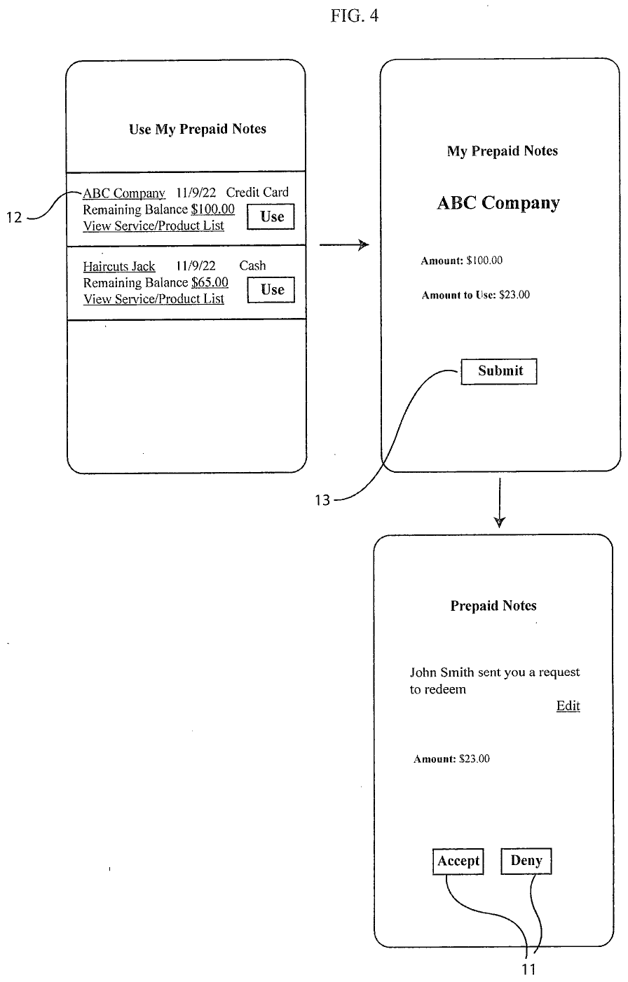

FIG. 4, discloses the prepaid note page after purchase, which can be further used for future transactions. The page reveals other information such as total number of prepaid notes and available prepaid notes owned, amount and dates (12), a submit option (13) and an option to accept or deny transaction after selection (11).

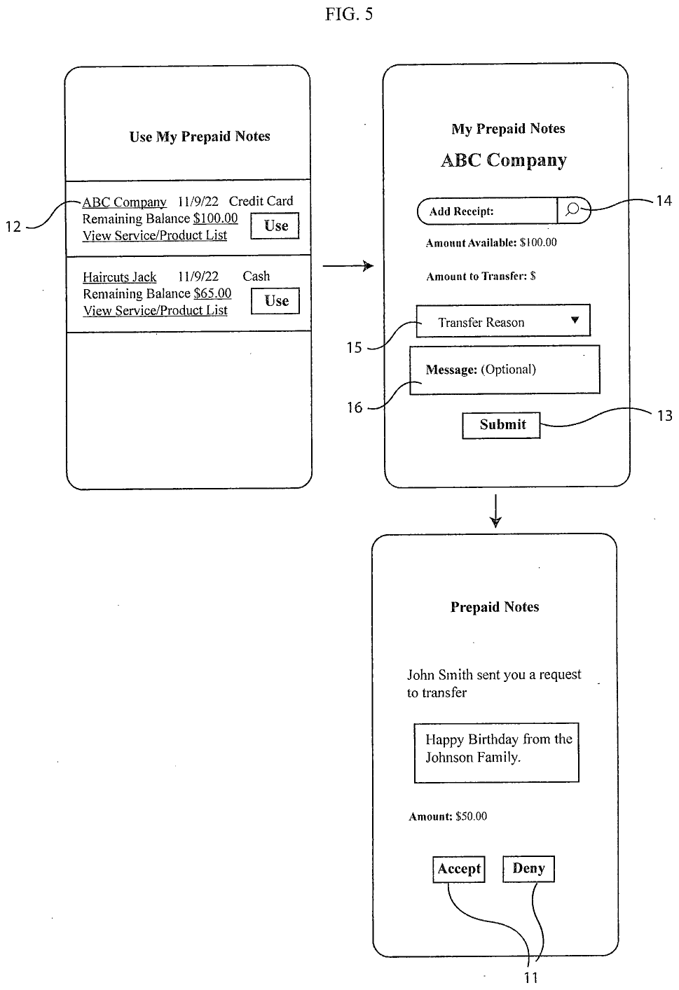

FIG. 5, discloses the pre-paid notes usage options platform of the current invention. The user can select from one or more of their already saved or purchased prepaid notes (12), add receipts to a transaction (14), transfer or gift friend, family members or relatives and also attach an optional short message to the receipt (17). The reason for transfer can also be selected (16), either to buy/sell, gift or other options. A submit option (13) and accept or deny option is also disclosed (11).

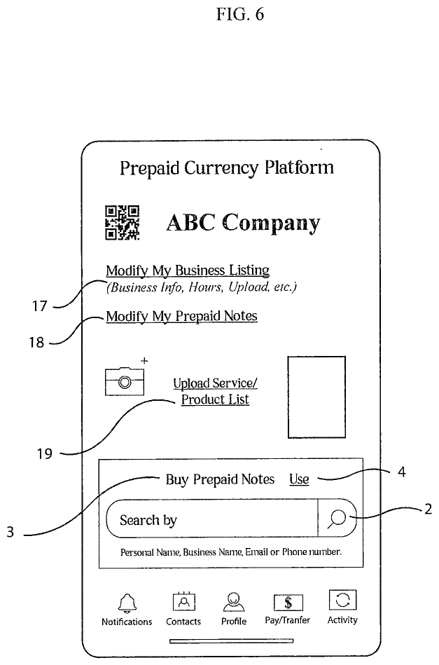

FIG. 6, disclose a business user view platform of the present invention. Users can buy in person at a business and go in their account and search for the user in search bar (2), or scan a QR Code for that user to their profile. Then businesses can enter the details for the purchase or let users use or redeem if they wanted to. A business user can modify its business listings (18), modify its prepaid notes (19), upload more services/product (20).

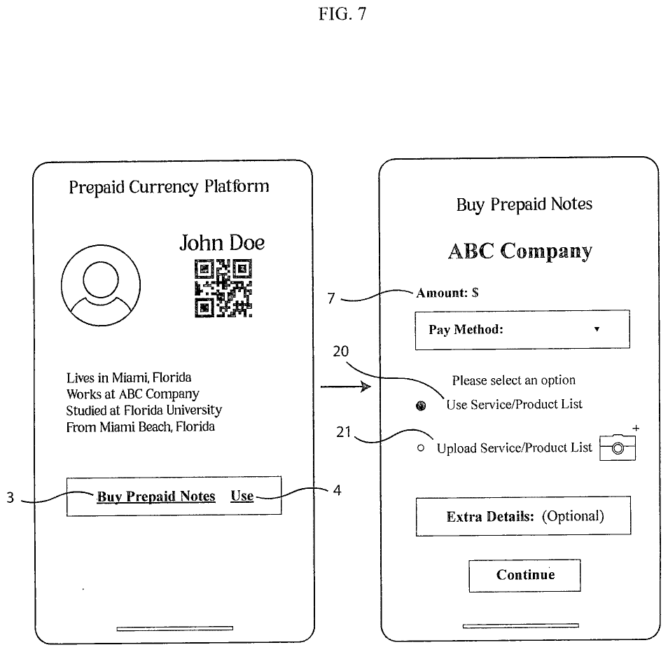

FIG. 7, disclose a business user view platform of the present invention, it further allows a business user buy prepaid note (3), input payment amount (7), upload and view services/product list as provided (20 &21), and use prepaid notes (4).

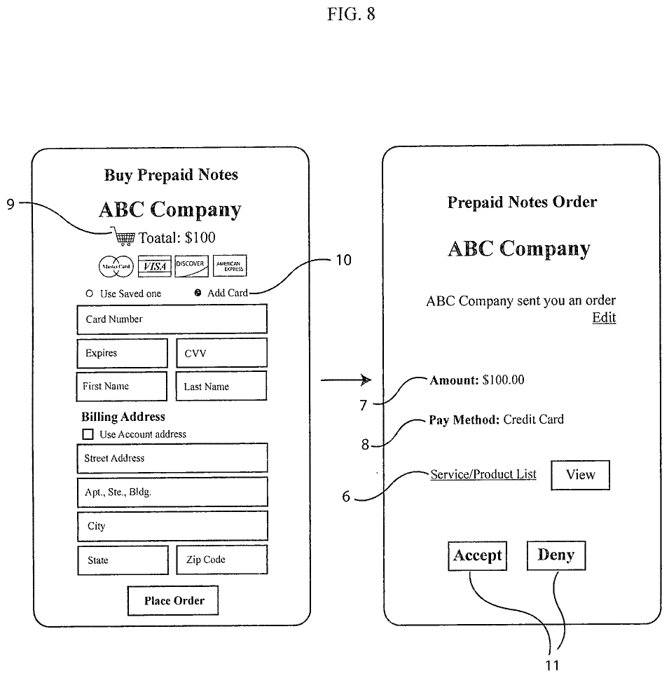

FIG. 8, discloses the business user platform order page of the present invention. This further reveals the company name and information, service product list (6), amount (7), payment method (8), total amount in cart (9), add card option (10), and billing information. The page further allows for an option to accept or decline transaction or order (11).

What is claimed is:

1. A system and method that provides users (individuals and businesses) with a computer implemented platform with the ability to facilitate prepaid transactions with other users. with the ability for products and services to be purchased/sold and record current prices on the platform;
thereafter transaction details are stored on the platform and both user accounts;
thereafter prepaid products and services can be redeemed anytime in the future, even years later and those original prices will be honored at redemption by vendor;

2. The method of claim 1, further comprising:
wherein said platform comprises of different modules which can be used alone or in combination;

3. The method of claim 1, further comprising:
wherein said platform allows individuals and businesses with the ability to securely and easily setup and track prepaid transactions, transfer of funds for the prepaid services and products, and other related functions with others in one convenient platform from account signup through to funds settlement;

4. The method of claim 1, further comprising:
wherein said platform allows Users (individuals and businesses) to access the platform from a cell phone, tablet, laptop computer, desktop computer or other related internet browser devices.

5. A system of methods that allows buyers to hedge against inflation by prepaying and buy products and services from business users on the platform.
thereafter transaction details are stored on the platform and both user accounts;
thereafter prepaid products and services can be redeemed anytime in the future, even years later and those original prices will be honored at redemption by vendor;

6. The method of claim 5, further comprising:
wherein said platform comprises of different modules which can be used alone or in combination;
wherein said platform allows individuals and businesses with the ability to securely and easily setup and track prepaid transactions, transfer of funds for the prepaid services and products, and other related functions with others in one convenient platform from account signup through to funds settlement;
wherein said platform allows Users (individuals and businesses) to access the platform from a cell phone, tablet, laptop computer, desktop computer or other related internet browser devices.
